(19) United States
(12) Patent Application Publication
(10) Pub. No.: US 2025/0075040 A1
(43) Pub. Date: Mar. 6, 2025

(54) CO-EVAPORATION OF MONOMER PAIRS FOR COVALENT ORGANIC FRAMEWORK FILM GROWTH

(71) Applicant: William Marsh Rice University, Houston, TX (US)

(72) Inventors: Jeremy Paul Daum, Houston, TX (US); Alec Ajnsztajn, Houston, TX (US); Sathvik Ajay Iyengar, Houston, TX (US); Rafael Verduzco, Houston, TX (US); Pulickel M. Ajayan, Houston, TX (US)

(73) Assignee: William Marsh Rice University, Houston, TX (US)

(21) Appl. No.: 18/817,919

(22) Filed: Aug. 28, 2024

Related U.S. Application Data
(60) Provisional application No. 63/579,466, filed on Aug. 29, 2023.

(51) Int. Cl. C08G 83/00; B01J 31/16; B01J 35/39

(52) U.S. Cl. CPC C08G 83/008; B01J 31/1691; B01J 35/39; B01J 2531/025

(57) ABSTRACT

Systems and methods for producing a covalent organic framework including providing a first monomer to a first zone in a furnace, a second monomer to a second zone in the furnace, and a substrate to a third zone in the furnace, where the third zone is located downstream from the first zone and the second zone. Systems and methods also include heating the furnace to a achieve temperature profile having a range of temperatures where the range of temperatures vaporizes the first monomer the second monomer. Systems and methods further include absorbing, onto the substrate, the first vaporized monomer and the second vaporized monomer to produce a covalent organic framework (COF). Articles produced by systems and methods include a film of a covalent organic framework (COF). The COF is a reaction product of a first monomer and a second monomer, and the COF is arranged in a two-dimensional crystalline lattice.

### CROSS REFERENCE TO RELATED APPLICATIONS

This application claims priority to U.S. Provisional Application Ser. No. 63/579,466, filed Aug. 29, 2023, entitled, “Co-evaporation of monomer pairs for covalent organic framework film growth,” which is hereby incorporated by reference.

### STATEMENT REGARDING FEDERALLY SPONSORED RESEARCH

This invention was made with government support under Grant No. 1842494 awarded by the National Science Foundation, and Grant No. FA9550-21-1-0460 awarded by the US Air Force Research Laboratories. The government has certain rights in the invention.

### BACKGROUND

Separation processes are a costly and complicated part of chemical production and wastewater treatment. Many processes, such as crude oil refinement, require a large amount of energy to distill useful compounds from complex mixtures. Other processes, such as wastewater treatment, require multiple components to capture undesired contaminates and break them down into less harmful products. An important example of is the removal of per- and polyfluoroalkyl substances (PFAs) from water sources. PFAs are a group of fluorinated carbon substances with an extremely long lifespan that are carcinogenic to humans and harmful to the environment, and the Environmental Protection Agency (EPA) has recently restricted PFAS discharge in industrial wastewater as a result. However, current technology utilizes ceramic powders with low surface areas as photocatalysts, such as boron nitride (BN) and titanium dioxide (TiO₂), to degrade PFAS. Further, the existing photocatalysts have low catalytic activity, meaning they are largely not very effective at removing harmful PFAs from water sources.

Covalent organic frameworks (COFs) have been speculated by the research community to be excellent membranes and catalyst hosts due to their aligned molecular pore structure. For example, several COFs have been shown to be photocatalytic for PFAS degradation and possess much higher internal surface area than conventional solutions due to their porous structure. Additionally, their chemically-defined pore size and designable (e.g., tunable) functional properties also allow for a wide variety of other applications, such as crude oil refinement, retrieval of precious metals from waste streams, desalination, carbon capture, oil-water separation, chiral separation in drug synthesis, and more. However, a lack of ability to either quickly synthesize these COFs or produce them in a form other than an insoluble powder has prevented industrial adoption. Therefore, there remains a need for improved COFs, articles containing them, and methods of making them.

This invention was funded in part by the Robert A. Welch Foundation under Welch Grant No. C-2124-20220331.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to methods for producing a covalent organic framework including providing a first monomer to a first zone in a furnace, a second monomer to a second zone in the furnace, and a substrate to a third zone in the furnace, where the third zone is located downstream from the first zone and the second zone. Methods also include heating the furnace to a achieve temperature profile having a range of temperatures including at least a first temperature range in the first zone, a second temperature range in the second zone and a third temperature range in the third zone, where heating the first zone to the first temperature range vaporizes the first monomer to form a first vaporized monomer and heating the second zone to the second temperature range vaporizes the second monomer to produce a second vaporized monomer, and where an average temperature of the third temperature range is lower than an average temperature of the first temperature range and an average temperature of the second temperature range. Methods also include absorbing, onto the substrate, the first vaporized monomer and the second vaporized monomer to produce a covalent organic framework (COF).

In another aspect, embodiments disclosed herein also relate to articles, including a film of a covalent organic framework (COF) including a reaction product of a first monomer and a second monomer, the COF being arranged in a two-dimensional crystalline lattice.

In yet another aspect, embodiments disclosed herein relate to systems for producing a covalent organic framework, including a furnace, a first monomer, disposed in a first zone within the furnace, a second monomer, disposed in a second zone within the furnace, and a substrate, disposed in a third zone within the furnace, wherein the third zone is located downstream from the first zone and the second zone. Systems of one or more embodiments also include a heating system in the furnace configured to heat the furnace to a temperature profile having a range of temperatures including at least a first temperature range in the first zone, a second temperature range in the second zone, and a third temperature range in the third zone, where heating the first zone to the first temperature range vaporizes the first monomer to form a first vaporized monomer and heating the second zone to the second temperature range vaporizes the second monomer to produce a second vaporized monomer, where an average temperature of the third temperature range is lower than an average temperature of the first temperature range and an average temperature of the second temperature range, and where, the first vaporized monomer and the second vaporized monomer absorb onto a surface of the substrate to produce the covalent organic framework (COF).

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIG. 1A is system according to one or more embodiments.

FIG. 1B is a schematic of a film grown on a substrate according to one or more embodiments.

FIG. 2 is a flowchart of a method according to one or more embodiments.

FIG. 3 shows a furnace temperature profile according to one or more embodiments.

FIG. 4 is a laboratory setup of a furnace according to one or more embodiments.

FIG. 5A is a reaction schematic of Example 1 according to one or more embodiments.

FIG. 5B is a chemical model of Example 1 according to one or more embodiments.

FIG. 6 is a chemical structure of Example 2 according to one or more embodiments.

FIG. 7 is a chemical structure of Example 3 according to one or more embodiments.

FIG. 8 is a chemical structure of Example 4 according to one or more embodiments.

FIG. 9 show a thickness profile of a film of Example 1 according to one or more embodiments.

FIG. 10 is a polarized optical microscope image of an Example 1 film according to one or more embodiments.

FIG. 11 is a polarized optical microscope image of an Example 2 film according to one or more embodiments.

FIG. 12 is a polarized optical microscope image of an Example 3 film according to one or more embodiments.

FIG. 13 is a polarized optical microscope image of an Example 4 film according to one or more embodiments.

FIG. 14 is an SEM image of an Example 1 film according to one or more embodiments.

FIGS. 15A-C are XPS spectra of an Example 1 film according to one or more embodiments.

FIG. 16 is an XPS spectrum of an Example 2 film according to one or more embodiments.

FIG. 17 is an XPS spectrum of an Example 3 film according to one or more embodiments.

FIG. 18 is an XPS spectrum of an Example 4 film according to one or more embodiments.

FIG. 19 shows Raman spectroscopy spectra of DETH, TFB, and an Example 1 film according to one or more embodiments.

FIG. 20 shows Raman spectroscopy spectra of p-phenylenediamine (PDA) monomer, TFB monomer, and an Example 2 film according to one or more embodiments.

FIG. 21 shows Raman spectroscopy spectra of PDA monomer, 1,3,5-triformylphloroglucinol (TFP) monomer, and an Example 3 film according to one or more embodiments.

FIG. 22 shows Raman spectroscopy spectra of 1,3,5-tris(4-aminophenyl)benzene (TAPB) monomer, terephthalaldehyde (TPA) monomer, and an Example 4 film according to one or more embodiments.

FIG. 23A is a grazing incidence wide angle x-ray diffraction (GIWAXS) scattering pattern of an Example 1 film according to one or more embodiments.

FIG. 23B is a 1D radially averaged linecut of the 2D GIWAXS pattern corresponding to FIG. 23A in the r-axis (parallel to the substrate) according to one or more embodiments.

FIG. 23C is a 1D radially averaged linecut of the 2D GIWAXS pattern corresponding to FIG. 23A in the z-axis (perpendicular to the substrate) according to one or more embodiments.

FIG. 24 is a high resolution transmission electron microscope (HRTEM) image of an Example 1 film according to one or more embodiments.

FIG. 25 is a second HRTEM image of an Example 1 film according to one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

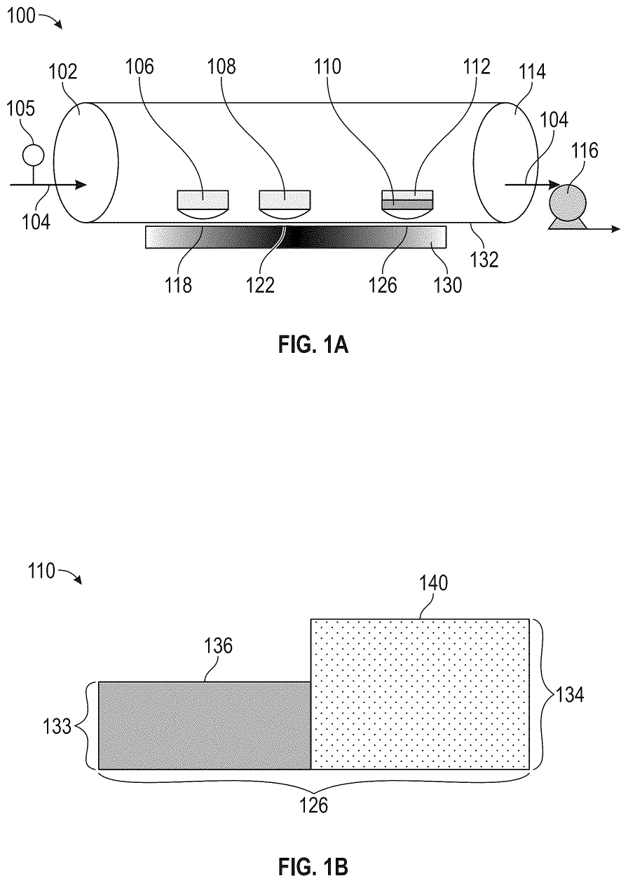

In the following description of FIGS. 1-25, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Covalent Organic frameworks (COFs) are a promising class of two-dimensional and three-dimensional (2D and 3D) crystalline porous polymers which may be assembled from a diverse range of monomers. COFs are particularly useful in a wide variety of applications including gas adsorption, membranes, and energy storage, due to their permanent porosity, versatile functionality, molecularly defined pore size, and tunable architecture. Conventional solution-based methods of producing COFs are marred by slow reactions that produce powders that are difficult to process into adaptable form factors for functional applications. While much work has gone into expanding this library of monomer sets for broadening structural and functional diversity, most COF synthesis approaches produce insoluble microcrystalline powders. These powders generally cannot be processed using traditional solvent casting methods, and this limits scale up and adoption of COF materials for various applications, such as nanofiltration, where high-quality membranes are needed, or device applications where a specific form factor is desired.

A variety of strategies have been developed to produce COF thin films, including colloidal synthesis, liquid-liquid interfacial polymerization, exfoliation, and re-casting. Colloidal synthesis can be used to create a stable suspension of COFs and produce gels. Liquid-liquid interfacial polymerization has been used to create films and membranes through reactions of monomers at the interface of two immiscible solvents. Exfoliation has been used to create a suspension of COF sheets that can be then cast into films via techniques such as spin coating. However, each of these techniques possesses some drawbacks for film formation including long reaction times, poor crystallinity, alignment, lack of thickness control, and unavoidable defects in the final film. Accordingly, there is a need for facile, fast, and scalable synthesis techniques for making crystalline and ordered COF thin films and coatings.

Chemical vapor deposition (CVD) provides a promising alternative synthetic method as compared to the aforementioned synthesis methods. CVD is a process which is already accepted and used by industry for producing semiconductor devices. CVD's inherent lack of solvent streams negates the need for wastewater cleanup, reducing operational expenses and enhancing environmental sustainability. CVD may also be used to produce 2D materials such as graphene, transition metal dichalcogenides, etc. In general, CVD process parameters such as temperature, pressure, and reactant flow rate influence the adsorption and diffusion of the precursors onto the substrate and allow for control over thickness, crystallite size, orientational ordering, and film uniformity. Additionally, the substrate size is only limited by the size of the reactor and hence can be adapted for large area film growth.

Embodiments disclosed herein generally relate to systems and methods for producing a COF and COF articles produced thereby. In some embodiments, a chemical vapor deposition (CVD) unit having a heating system providing a variable temperature profile is used to produce COF articles disclosed herein. COF articles disclosed herein generally include coatings and films having desirable mechanical and chemical properties, including uniform thickness, high crystallinity, ordered crystalline structure, relatively little defects, low surface roughness, chemical integrity (e.g., no degradation of monomers), high surface area, among others. Desirable properties will be defined and described in more detail in the following sections.

### Covalent Organic Framework (COF) Compositions

As described above, covalent organic frameworks COFs are crystalline porous polymers which may be assembled from a diverse range of monomers. A COF as described herein may be used as an organic absorbent. The COFs described herein have a modular nature. The COFs may be made from monomers that are bonded through linkages. The COFs described herein may be formed with suitable linkage chemistries, for example imine, imide, hydrazone, and olefin connections. The COFs may include suitable functional linkages, for example imines, phosphates, thiols, and carboxylic acids. The COFs and their resulting properties may be tuned, making them suitable for a range of applications. The properties that may be tuned include optoelectronic properties, semiconductivity, hydrophobicity (surface energy), size exclusion, and various catalytic potentials.

COFs according to one or more embodiments disclosed herein include a first monomer and a second monomer, where the first monomer and the second monomer react in a reversible condensation reaction to form covalent bonds and produce the COF. As would be understood by one of ordinary skill in the art, the chemical structure of COFs disclosed herein may depend on the specific monomers used in synthesizing the COF. Generally, the chemical structure of a COF includes a two-dimensional or three-dimensional structure formed by the monomers which inherently leads to a high degree of long-range ordering and high crystallinity.

COFs as described herein are generally a reaction product of a first monomer having an aldehyde group, and a second monomer having an amine group, such that the aldehyde and the amine react to form the COF. As such, in one or more embodiments, the first monomer is a monomer containing at least one aldehyde end group. Examples of a first monomer of one or more embodiments include 1,3,5-triformylbenzene (TFB), 1,3,5-triformylphloroglucinol (TFP), terephthalaldehyde (TPA), 2,5-dihydroxy-1,4,benzenedicarboxaldehyde (DHTA), 4,4′-(Buta-1,3-diyne-1,4-diyl)dibenzaldehyde, thieno[3,2-b]thiophene-2,5-dicarbaldehyde, diylbis(azanetriyl))tetrabenzaldehyde, and the like.

In one or more embodiments, the second monomer is a monomer containing at least one of an amine, an imine, an imide, or a hydrazide end group. Examples of a second monomer according to one or more embodiments include 2,5-diethoxyterephthalohydrazide (DETH), p-phenylenediamine (PDA), 1,3,5-tris(4-aminophenyl)benzene (TAPB), 4,4,4,4-(1,3,6,8-Pyrenetetrayl)tetrakis[benzenamine], 5,10,15,20-Tetrakis(4-aminophenyl)-21H,23H-porphine, and the like. While the aforementioned lists of first and second monomers include exemplary monomers, one of ordinary skill in the art will appreciate that a vast number of monomers can be used in accordance with the present disclosure, provided they have the appropriate end groups as previously described.

### System for Producing Covalent Organic Frameworks

In one aspect, embodiments disclosed herein relate to systems for producing a covalent organic framework (COF). FIG. 1A shows a system 100 for producing a covalent organic framework according to one or more embodiments. The system 100 shown in FIG. 1A includes a furnace 132 and a heating system 130.

The furnace 132 of one or more embodiments may be a tube furnace, a chemical vapor deposition system, or the like.

The heating system 130 of one or more embodiments may be any device capable of producing a temperature profile within the furnace 132. For example, the heating system 130 may be a substantially flat heating plate configured to heat different lateral positions of the furnace 132 to desired temperatures. Alternatively, the heating system 130 may radially surround an outer circumference of the furnace 132 (not shown in the figures) and be configured to heat different zones within the tube furnace to desired temperatures. As is understood by those skilled in the art, tube furnaces (and other types of furnaces) may include insulation in order to achieve consistent heating throughout an area of a furnace. However, according to one or more embodiments disclosed herein, the amount of insulation can be modified, and in some instances, insulation can be removed entirely, in order to achieve a more varied temperature profile in the furnace. As such, the furnace 132 of one or more embodiments may or may not be equipped with insulation. In the embodiment shown in FIG. 1A, there is no insulation.

Returning to FIG. 1A, in one or more embodiments the system 100 may further include a vacuum pump 116. The vacuum pump 116 may be located on a downstream side 114 of the furnace 132 and may and configured to draw a vacuum within the furnace 132. In one or more embodiment, the vacuum pump 116 may depressurize the furnace 132 to a pressure in a range of from about 0.001 to about 10 Torr. For example, the vacuum pump may depressurize the furnace to a pressure in a range having a lower limit of any one of about 0.001, 0.01, and 1 Torr to an upper limit of any one of about 5, 7.5, and 10 Torr, where any lower limit may be paired with any mathematically compatible upper limit. The vacuum pump may be any vacuum pump known in the art.

In some embodiments, the system 100 may further include an inert gas source 104. The inert gas source 104 may be fluidly connected to the furnace 132 and configured to flow an inert gas through the furnace 132 from an upstream side 102 to a downstream side 114. The inert gas may be any known in the art, including Ar, N, He, and combinations thereof.

In one or more embodiments, the system 100 may further include a flow control device 105 coupled to the inert gas source 104. The flow control device 105 may be configured to flow the inert gas through the furnace 132 at a flow rate in a range of from 10 to 300 standard cubic centimeters (sccm) in a tube of a 3-inch inner diameter, or proportionally more or less scaling with tube diameter. For example, the flow control device may be configured to flow the inert gas at a flow rate in a range having a lower limit of any one of about 10, 50, and 100 sccm to an upper limit of any one of about 150, 200, and 300 sccm, where any lower limit may be paired with any mathematically compatible upper limit. The flow control device 105 may be any suitable flow control device capable of controlling a flow of inert gas. Examples of a flow control device 105 include gas needle, gas fine needle, and gas ball valves.

In one or more embodiments, the system may also include a first monomer 106 disposed in a first zone 118, a second monomer 108 disposed in a second zone 122, and a substrate 110 disposed in a third zone 126 within the furnace 132. In one or more embodiments, the third zone 126 is located at a downstream position (e.g., on the downstream side 114) within the furnace 132 compared to the first zone 118 and the second zone 122. The first monomer and the second monomer may include any monomer as described in the sections above.

The substrate may be any suitable material known in the art. Examples of a substrate include Si/SiO₂, fabrics, alumina, inorganic foam, inorganic mesh, metal sheet, metal surfaces, glasses, fibers, plastics, and power materials, among others. However, as will be understood by those skilled in the art, the CVD method allows for substantial flexibility in terms of what type of substrates can be used. Therefore, a wide variety of substrates may be employed and can vary based on the desired end use of the COF.

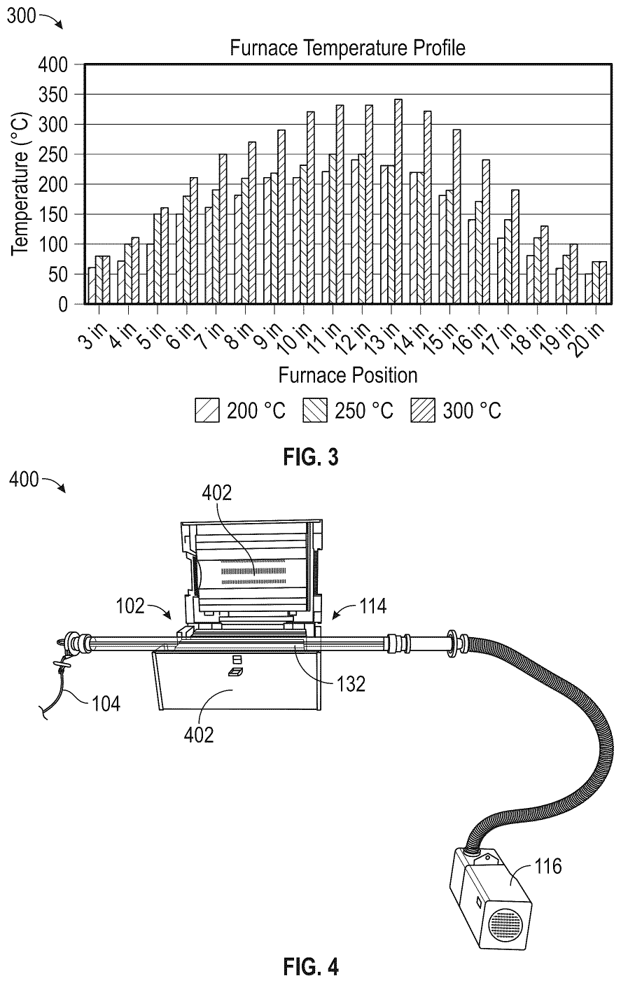

The heating system 130 may be configured to heat the furnace 132 to a temperature profile having a range of temperatures. An example temperature profile is presented in FIG. 3 and will be discussed in more detail in the Examples section below. The range of temperatures in the temperature profile may be in a range of from about 50° C. to about 450° C. For example, the temperature profile may be in a range having a lower limit of any one of about 50° C., 100° C., and 150° C. to an upper limit of any one of about 250° C., 350° C., and 450° C., where any lower limit may be paired with any mathematically compatible upper limit. As would be understood by one of ordinary skill in the art, the range of temperatures may vary depending on the type of monomer(s), type of furnace, pressure within the furnace, and the like.

In one or more embodiments, the range of temperatures includes a first temperature range in the first zone 118, a second temperature range in the second zone 122, and a third temperature range in the third zone 126. In one or more embodiments, heating the first zone 118 to the first temperature range vaporizes the first monomer 106 to form a first vaporized monomer. Similarly, heating the second zone 122 to the second temperature range vaporizes the second monomer 108 to produce a second vaporized monomer. In one or more embodiments, a boiling point of the first monomer is within the first temperature range and a boiling point of the second monomer is within the second temperature range. Accordingly, in one or more embodiments, the first vaporized monomer and the second vaporized monomer may be carried by the inert gas to a downstream side 114 within the furnace 132. The first vaporized monomer and the second vaporized monomer may then each absorb onto a surface of the substrate and react to produce the covalent organic framework (COF). However, as noted above, in one or more embodiments, reduced pressure may be applied in the furnace by using a vacuum. As such, monomers that have boiling points that are not within the temperatures of the first and second zones may be used as they can be vaporized via a combination of elevated temperature and reduced pressure.

FIG. 1B is a schematic of a substrate 110 located in the third zone 126 of the furnace 132. In one or more embodiments, the third zone 126 further includes at least a first substrate location 136 having a first substrate temperature within the third temperature range. Furthermore, the third zone 126 may further include a second substrate location 140 having a second substrate temperature within the third temperature range. As would be understood by one of ordinary skill in the art, while only two substrate positions and temperatures are shown, the third temperature range may include any number of temperatures associated with a substrate position. The temperature at each substrate position may affect a thickness of a COF film formed on the substrate according to methods disclosed herein, as will be described below. As such, substrates may be chosen with an appropriate length or other dimension to achieve a desired temperature profile (and corresponding COF thickness profile) along the substrate.

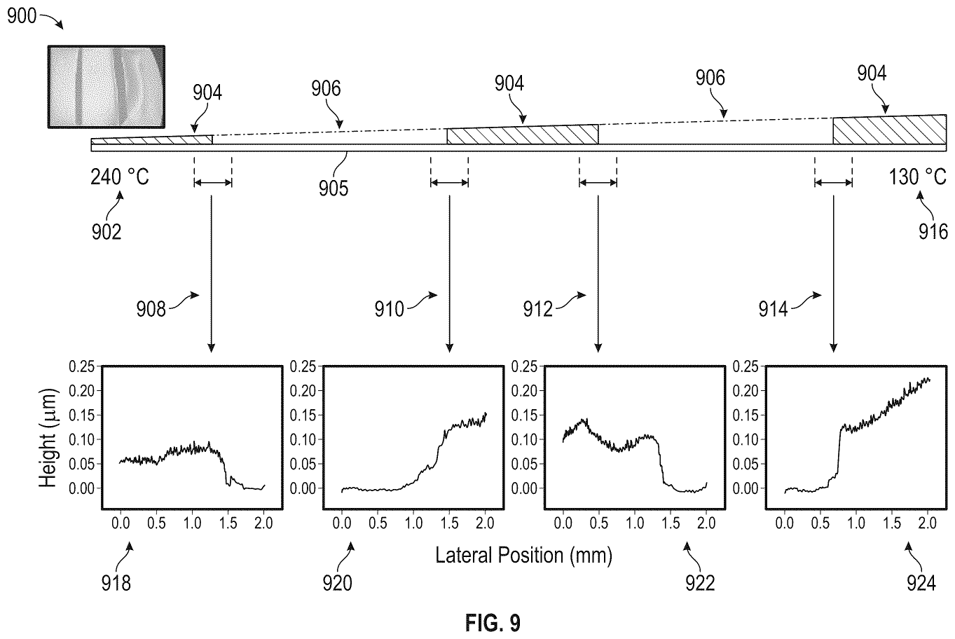

In one or more embodiments upon forming a COF on the substrate 110, the COF may have a first thickness 133 at the first substrate location 136 and a second thickness 134 at the second substrate location 140. The first thickness 133 is greater than the second thickness 134 when the first substrate temperature is lower than the second substrate temperature. Similarly, the first thickness 133 is less than the second thickness 134 when the first substrate temperature is higher than the second substrate temperature. Changing a substrate position within the furnace (and thus changing a substrate temperature) may therefore be used to obtain a desired COF film thickness according to embodiments disclosed herein. While it may be appreciated that a specific temperature of the substrate may lead to a specific COF film thickness, as the lateral size of the substrate increases, the temperature may include a range of temperatures and the thickness may include a range of thicknesses (for example, as illustrated in FIG. 9).

### Methods for Producing Covalent Organic Frameworks

In another aspect, embodiments disclosed herein relate to a method for producing a covalent organic framework (COF). The COFs produced by methods described in the sections below may be any of the COFs described herein.

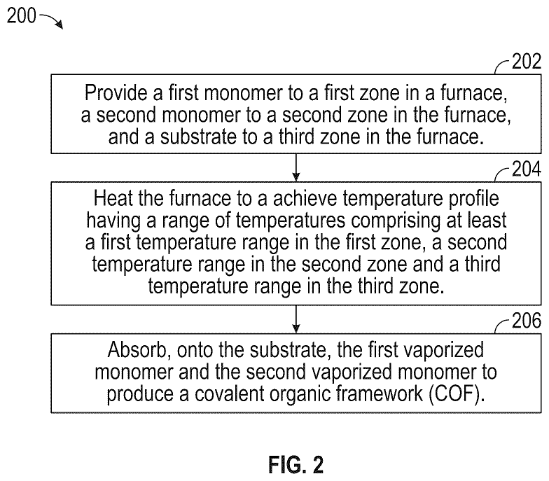

FIG. 2 is a flowchart of a method 200 according to one or more embodiments. In one or more embodiments, methods for producing a COF may include, in step 202, providing a first monomer to a first zone in a furnace, a second monomer to a second zone in the furnace, and a substrate to a third zone in the furnace. In one or more embodiments, the third zone is located downstream from the first zone and the second zone.

The first monomer and the second monomer may include any of the monomers as described in sections above. The amount of first monomer and second monomer provided to the first and second zones, respectively, may vary depending on several factors including monomer type and molecular weight. In one or more embodiments, a stoichiometric molar ratio of the first monomer and the second monomer may be placed in the furnace to produce a COF according to methods disclosed herein.

In one or more embodiments, the method further includes mixing one or more of the first monomer and the second monomer with a stabilizer. Mixing of the stabilizer may be done prior to providing the first and/or the second monomer to the furnace. A stabilizer is defined herein as a sacrificial powder which has a greater affinity to absorb ambient moisture than a functional group located on the first monomer or the second monomer. The stabilizer may advantageously increase yield and quality of the reaction. In one or more embodiments, if a stabilizer is not added, the reaction yield may decrease, and unreacted monomer left on the substrate surface may reduce the quality of the synthesized COF. However, the COF can be formed without the use of a stabilizer. In one or more embodiments, the stabilizer may be iron powder.

In one or more embodiments, the method further includes drawing a vacuum within the furnace. Upon drawing the vacuum, the furnace may have a pressure in a range of from about 0.001 to about 10 Torr. For example, the vacuum pump may depressurize the furnace to a pressure in a range having a lower limit of any one of about 0.001, 0.01, and 1 Torr to an upper limit of any one of about 5, 7.5, and 10 Torr, where any lower limit may be paired with any mathematically compatible upper limit.

In one or more embodiments, the method further includes flowing an inert gas through the furnace at a flow rate in a range of from about 10 to about 300 sccm in a tube of a 3-inch inner diameter, or proportionally more or less scaling with tube width. For example, the inert gas may be flowed at a flow rate in a range having a lower limit of any one of about 10, 50, and 100 sccm to an upper limit of any one of about 150, 200, and 300 sccm, where any lower limit may be paired with any mathematically compatible upper limit.

Returning to FIG. 2, in one or more embodiments, the method 200 also includes, in step 204, heating the furnace to a achieve temperature profile having a range of temperatures. The range of temperatures may include at least a first temperature range in the first zone, a second temperature range in the second zone and a third temperature range in the third zone. In the method 200, heating the first zone to the first temperature range may vaporize the first monomer to form a first vaporized monomer. Similarly, heating the second zone to the second temperature range may vaporize the second monomer to produce a second vaporized monomer. Furthermore, an average temperature of the third temperature range may be lower than an average temperature of the first temperature range and an average temperature of the second temperature range.

In one or more embodiments, the first monomer has a boiling point in the first temperature range and the second monomer has a boiling point in the second temperature range. Additionally, when the boiling point of the first monomer is lower than the boiling point of the second monomer, the first zone is located upstream from the second zone, and when the boiling point of the first monomer is higher than the boiling point of the second monomer, the first zone is located downstream from the second zone.

In one or more embodiments, heating the furnace occurs for a suitable amount of time to allow for a reaction of the first monomer and the second monomer to occur. For example, heating the furnace may occur for an amount of time in a range of less than about 30 min. For example, heating the furnace may occur for an amount of time of less than 30 min, less than 25 min, less than 20 min, less than 10 min, less than 5 min, or less than 1 min.

Keeping with FIG. 2, in one or more embodiments, the method 200 further includes, in step 206, absorbing, onto the substrate, the first vaporized monomer and the second vaporized monomer to produce a covalent organic framework (COF).

In one or more embodiments, the third zone includes at least a first substrate location having a first substrate temperature within the third temperature range and a second substrate location having a second substrate temperature within the third temperature range. Additionally, the COF may have a first thickness at the first substrate location and a second thickness at the second substrate location, where the first thickness is greater than the second thickness when the first substrate temperature is lower than the second substrate temperature and the first thickness is less than the second thickness when the first substrate temperature is higher than the second substrate temperature.

In one or more embodiments, the method further includes etching the substrate with an acid to release the COF from the substrate. In one or more embodiments, the acid may be hydrofluoric acid (HF) having a concentration of about 0.5 vol % HF in water. Etching techniques in accordance with the present disclosure are known in the art and may be adapted/adjusted as appropriate. Etching the substrate to release the COF may advantageously allow for additional testing and characterization of the COF according to one or more embodiments. Details of testing and characterization will be presented in the Example section below.

### Covalent Organic Framework Article

In another aspect, embodiments disclosed herein relate to a covalent organic framework (COF) article, including a COF film or COF coating. The article may be a COF of a reaction product of a first monomer and a second monomer, where the COF is arranged in a two-dimensional (2D) crystalline lattice. The COF article may be any of the COFs described herein.

In one or more embodiments, the COF article may have a thickness in a range of from about 20 nm to about 1000 nm. For example, the COF article may have a thickness in a range having a lower limit of any one of 20 nm, 50 nm, and 100 nm to an upper limit of any one of 250 nm, 500 nm, and 1000 nm, where any lower limit may be paired with any mathematically compatible upper limit.

Embodiments disclosed herein may advantageously produce a COF article having a uniform thickness. As described above, the COF thickness varies with a temperature (and therefore position) of a substrate upon which it absorbs. Accordingly, it would be understood by one of ordinary skill in the art that a “uniform thickness” may apply to a specific substrate temperature. Accordingly, the uniform thickness may be controlled by maintaining the substrate at a specific temperature across the length or other dimension of the substrate.

The COF article may have a molecular pore size in a range of from about 0.5 Å to 80 Å. For example, the COF article may have a molecular pore size in a range having a lower limit of any one of 0.5 Å, 1 Å, and 10 Å to an upper limit of any one of 20 Å, 50 Å, and 80 Å, where any lower limit may be paired with any upper limit.

Applications and advantages of COF articles produced with systems and methods disclosed herein may include one or more of the following. Embodiments disclosed herein will allow for highly processable COF films and coatings to be produced rapidly for applications such as separations, electronics, and heterogenous catalysis. Due to their chemically defined, aligned pores and designable functional handles, COFs articles may be incorporated into COF films and coatings used for membrane separation and functional coatings. COF membranes may be used to replace energy intensive distillation for crude oil refinement, as well as retrieve precious metals from waste streams, desalination, carbon capture, hydrophobic coating that can be used in oil-water separation, toxin removal, chiral separation in drug synthesis, and the like.

COF coatings may be used to alter surface hydrophobicity, hydrophilicity, color, and the like. In addition, COF films and coatings may be incorporated into installable columns or filters for per- and polyfluoroalkyl substances (PFAS) degradation and membrane separation. COFs produced according to embodiments disclosed herein may be used to efficiently degrade robust, federally restricted chemicals, such as PFAS. Contaminated industrial wastewater may also be flowed through these COFs to degrade and release these harmful compounds.

COF films produced according to embodiments disclosed herein may be used in the following applications: as high-quality size exclusion membranes, catalytic platforms, nanofiltration, organic electronics, and heterogenous catalysis.

### EXAMPLES

The following Examples are provided for the purpose of further illustrating the present inventions and are in no way intended to be limiting.

In the examples, monomers were bought commercially from Ambeed or TCI and used without further purification.

### Furnace Temperature Profile

A tube furnace (Thermo Scientific, Lindberg Blue M) was used as a reactor with a 44 mm internal diameter (ID) quartz tube. An Edwards Vacuum Pump RV12 10 cfm was used to maintain a vacuum of 3 torr, measured by an Inficon vacuum gauge (PCG550 Pirani Capacitance Gauge with Tungsten Filament).

Thermal blocks that insulate and maintain an even temperature across the center of the tube furnace were removed from the furnace to create a heat gradient (i.e., temperature profile). The removal of insulating blocks causes heat to be able to escape through the sides and the center to have to be overheated to overcome heat loss. The generated heat gradient helps heat monomers of different vapor pressures simultaneously at different positions within the furnace, as well as allowing for monomers to deposit on substrates of multiple temperatures in the same reaction.

FIG. 3 shows a bar chart of average temperatures for the temperature profile across a lateral length of the tube furnace according to embodiments disclosed herein. In FIG. 3, a measured temperature is shown versus furnace position (e.g., a length in inches of positions disposed laterally from the left-hand side to the right-hand side throughout the tube furnace). The temperature profile reported in FIG. 3 was measured by placing ceramic trays end to end across the length of the furnace within the quartz tube to mimic the temperatures that the monomers and Si/SiO₂ substrates would conduct during CVD. The tube was pumped down to 3 torr ultra-high purity Argon (UHP Ar) gas was flowed at 100 standard cubic centimeters (sccm). Each bar in FIG. 3 represents a different dwell temperature (200° C., 250° C., and 300° C.). The furnace temperature was set to the dwell temperature and the tube dwelled for the duration of the test. The dwell time for all examples was between 1 min and 30 min. After the temperature stabilized (e.g., after about 10 minutes), the furnace was quickly opened and temperatures were measured at one-inch intervals along a lateral length of the tube using an Etekcity Infrared Thermometer 774, Digital Temperature Gun. The process was repeated three times for accuracy and the temperature values were averaged together, rounded to the nearest 10° C., and plotted in FIG. 3. Appropriate monomer positions were then determined according to the boiling point reported in the corresponding safety data sheet (SDS) for each monomer. Si substrates were placed along one-inch (in) intervals ranging from 14 in to 19 in in lateral position within the length of the tube furnace (e.g., at temperatures corresponding to 320° C. to 100° C.).

The laboratory setup 400 is shown in FIG. 4. As described in FIG. 1A, the laboratory setup 400 includes an inert gas source 104 fluidly connected to an upstream side of a furnace 132. The furnace 132 may be radially surrounded by a heating system 402. At a downstream side 114 of the furnace 132, a vacuum pump 116 may be used to draw a vacuum within the furnace 132. Embodiments disclosed herein may be advantageously scaled up to industrial size, for example, by using a larger CVD which is currently employed in the semiconductor industry.

### Example 1

Example 1 is a covalent organic framework (COF) synthesized according to methods disclosed herein.

Example 1 was prepared via chemical vapor deposition (CVD) using a tube furnace (Thermo Scientific, Lindberg Blue M, 44 mm internal diameter quartz tube). A temperature profile according to methods disclosed herein was induced within the tube furnace by removing the thermal blocks of the tube furnace to produce a varied temperature profile.

The tube was preheated to 300° C. and allowed to dwell for 10 min prior to synthesis of Example 1. Two monomers, namely, 0.035 millimoles (mmol) of 2,5-diethoxyterephthalohydrazide (DETH) (obtained from Ambeed, 97.00% purity) and 0.035 mmol of 1,3,5-triformylbenzene (TFB) (obtained from Ambeed, 96.00% purity), were placed in ceramic trays in the tube furnace. The DETH monomer was placed downstream of the TFB monomer (e.g., closer to the center of the tube furnace) based on the higher vapor pressure of DETH. Prior to placing the DETH powder in the ceramic dish, the DETH powder was mixed with 10 mg iron powder (obtained from Sigma Aldrich, having particle size of 325 mesh and 97% purity) to prevent oxidation. The DETH and TFB monomers were chosen due to the predicted excellent stability of the hydrazone linkage in the synthesized COF. Silicone substrates (SiO₂/Si wafers obtained from University Wafer, with 300 nm Wet Thermal Oxide and a Thickness Tolerance of +/−7%) were prepared by covering vertical strips of the substrate with silicon (Si) to create gaps in the COF film during synthesis in order to accurately test film height at intermediate zones (e.g., since the substrate thickness is known). The prepared silicone substrates were placed at a downstream side of the tube furnace compared to the location of the two monomers.

Upon placing the monomers and the substrates in the tube, the tube was evacuated to 3 torr and 100 standard cubic centimeter (sccm) of ultrahigh purity (UHP) argon gas was flowed through the tube, the TFB and DETH monomers were heated to 290° C. and 330° C., respectively, for 20 minutes and substrates heated in temperature zones ranging from 320° C. to 100° C. Under these conditions, the monomers vaporized and travelled down the length of the tube, carried by the slow flow of Ar gas. The monomers deposited on the Si substrate and reacted to form a COF film. Co-evaporation of the DETH and TFB monomers onto the substrates after heating the monomers produced crystalline, oriented samples having a large 4×5 cm and smaller 1×1 cm size.

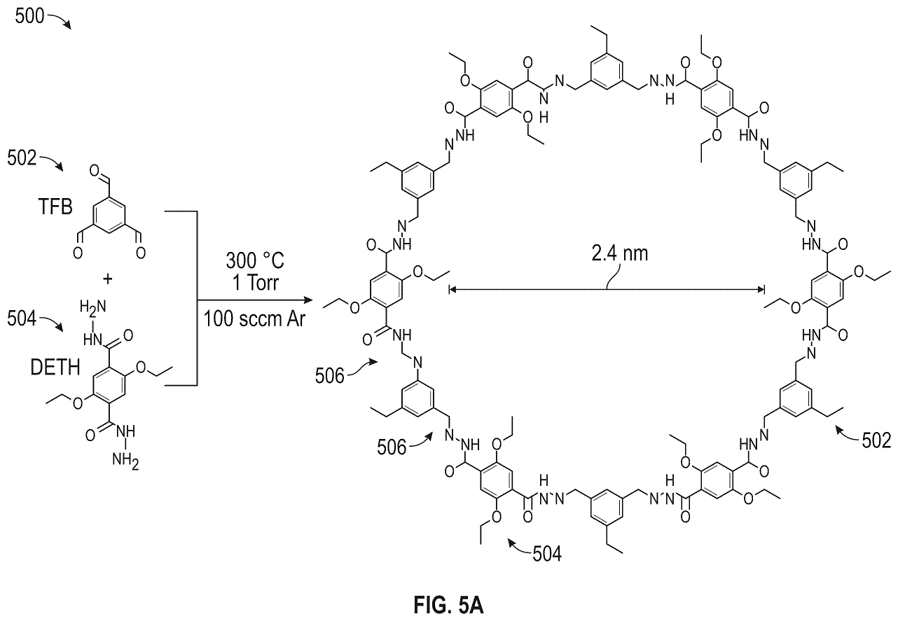

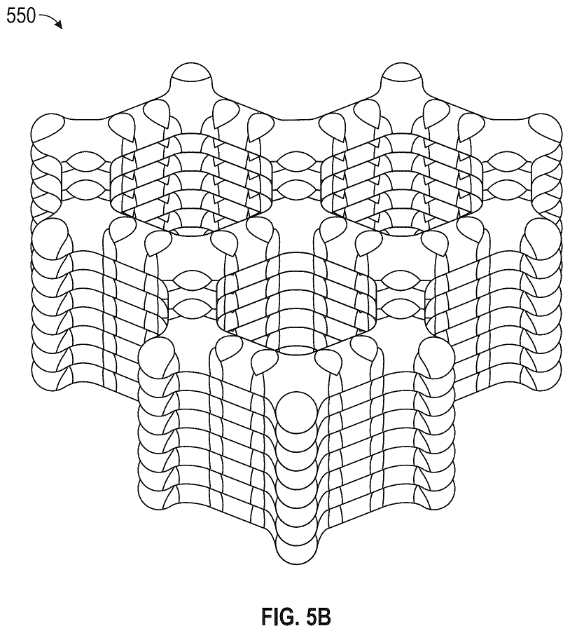

FIG. 5A shows a chemical reaction scheme 500 for synthesizing Example 1 from TFB monomer 502 and DETH monomer 504 linked together by hydrazone linkage 506. FIG. 5B shows a theoretical molecular model 550 of the COF synthesized via Example 1.

### Example 2

Example 2 is a COF film produced according to systems and methods disclosed herein. Example 2 was synthesized using the procedure outlined above for Example 1, except that two monomers, namely 0.035 mmol of p-phenylenediamine (PDA) (obtained from Aldrich, assay purity>99.00%) and 0.035 mmol of 1,3,5-triformylbenzene (TFB) (obtained from Ambeed, purity 96.00%), were heated to 210° C. and 220° C., respectively for 5 minutes. Prior to heating, the PDA powder was mixed with 10 mg iron powder (obtained from Sigma Aldrich, having particle size of 325 mesh and 97% purity) to prevent oxidation. SiO₂/Si substrates were placed downstream of the monomers in temperature zones ranging from 210° C. to 60° C.

All films of Example 1 were synthesized using a furnace temperature of 340° C. for 20 min on a Si/SiO₂ substrate at 260° C. unless otherwise noted.

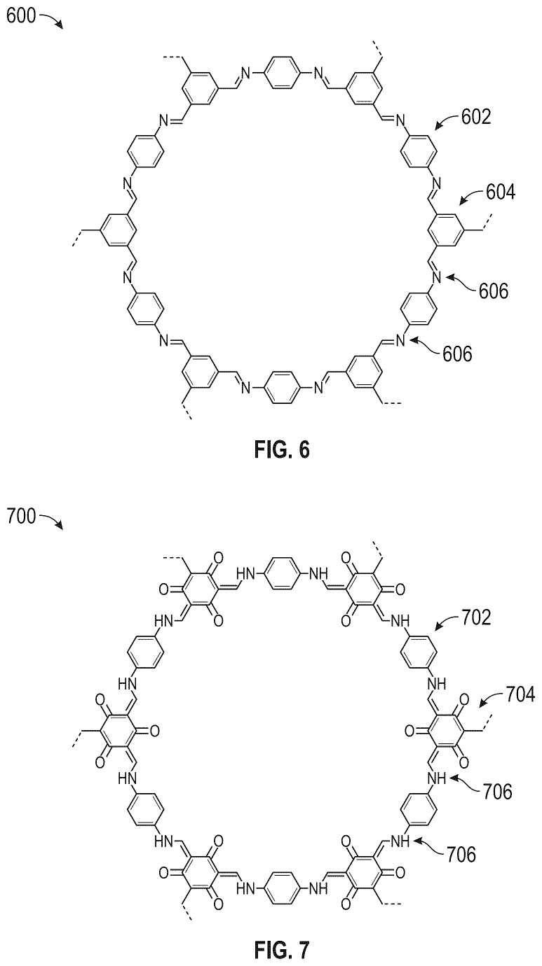

Example 2 is an example of an imine-linked COF. The monomers chosen to synthesize an imine-linked COF according to Example 2 were selected due to the similar vaporization temperature of its monomers. FIG. 6 shows a chemical structure 600 of a COF of Example 2 synthesized from PDA monomer 602 and TFB monomer 604 and having imine linkages 606.

### Example 3

Example 3 is a COF film produced according to systems and methods disclosed herein. Example 3 was synthesized using the procedure outlined above for Example 1, except that two monomers, namely 0.035 mmol of p-phenylenediamine (PDA) (obtained from Aldrich, assay purity>99.00%) and 0.035 mmol of 1,3,5-triformylphloroglucinol (TFP) (obtained from Alfa Asaar, purity 95%) were heated to 210° C. and 250° C., respectively for 5 minutes. Prior to heating, the PDA powder was mixed with 10 mg iron powder (obtained from Sigma Aldrich, having particle size of 325 mesh and 97% purity) to prevent oxidation. SiO₂/Si substrates were placed downstream of the monomers in temperature zones ranging from 210° C. to 80° C.

Example 3 is an example of a β-ketoenamine-linked COF. The monomers chosen to synthesize a β-ketoenamine-linked COF according to Example 3 were selected to observe the effects of different functional groups on deposited COF films, as well as testing the formation of a β-ketoenamine-linked COF by CVD. FIG. 7 shows a chemical structure 700 of a COF of Example 3 synthesized from PDA monomer 702 and TFP monomer 704 and having β-ketoenamine linkages 706.

### Example 4

Example 4 is a COF film produced according to systems and methods disclosed herein. Example 4 was synthesized using the procedure outlined above for Example 1, except that two monomers, namely 0.035 mmol of 1,3,5-tris(4-aminophenyl)benzene (TAPB) (obtained from Ambeed, purity 97+%) and 0.035 mmol of terephthalaldehyde (TPA) (obtained from Ambeed, purity 97%) were heated to 250° C. and 210° C., respectively for 10 minutes. Prior to heating, the TPA powder was mixed with 10 mg iron powder (obtained from Sigma Aldrich, having particle size of 325 mesh and 97% purity) to prevent oxidation. SiO₂/Si substrates were placed downstream of the monomers in temperature zones ranging from 210° C. to 80° C.

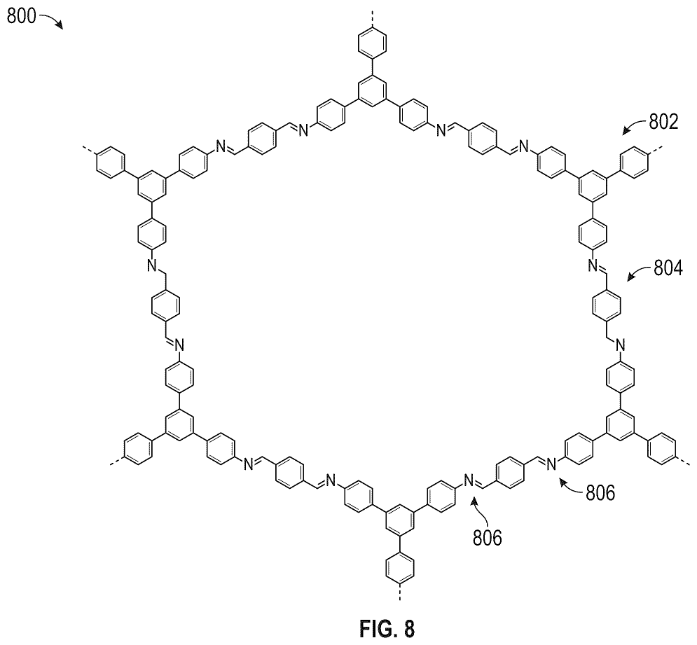

Example 4 is an example of an imine-linked COF. The monomers chosen to synthesize an imine-linked COF according to Example 4 were selected to observe the effects of synthesizing a COF film using monomers having a large difference in melting points (greater than 50° C.). Using monomers with a large difference in melting points generally leads to a larger molecular pore size. FIG. 8 shows a chemical structure 800 of a COF of Example 4 synthesized from TAPB monomer 802 and TPA monomer 804 and having imine linkages 806.

### COF Film Characterization

COF films synthesized in Example 1, Example 2, Example 3, and Example 4 were tested according to the following procedures.

### Film Thickness Testing—Contact Profilometry

A 4 cm by 5 cm area of Example 1 was measured for film thickness using a NPFLEX optical profiler. A gradual increase in film thickness from approximately 50 nm to over 200 nm as the substrate temperature decreased was observed. Gaps in the COF film were created during synthesis by covering vertical strips of substrate with Si to accurately test film height at intermediate zones.

FIG. 9 show film thickness testing results for Example 1. In FIG. 9, a measured film thickness versus lateral position is shown for four different substrate positions at corresponding substrate temperatures. Shown above the plotted thickness profile data is a representative drawing of COF film Example 1, illustrating relative positions where the synthesized COF was tested for thickness and the corresponding plotted thickness profiles in FIG. 9.

FIG. 9 shows how substrate temperature affects thickness of a COF film synthesized according to Example 1. Specifically, as the substrate temperature decreases from an upstream temperature 902 (e.g., 240° C.) to a downstream temperature 916 (e.g., 130° C.) thickness of the COF film increases. As shown in the FIG. 9, a lower substrate temperature produces a thicker COF film and vice versa.

In FIG. 9, a COF film 904 of Example 1 is formed on a Si/SiO₂ substrate 905, with stripped areas 906 as described above. A first location 908 having a first portion of COF film 904 on the substrate 905 has a thickness profile shown in 918, where the first average film thickness is about 0.05 μm to about 0.075 μm. Moving from the upstream temperature 902 toward the righthand side of the COF film 904, a second location 910 having a second portion of COF film 904 has a thickness profile shown in 920, where the second average film thickness is about 0.05 μm to about 0.125 μm. Moving further to the righthand side of the second location 910, a third location 912 having a third portion of COF film 904 has a thickness profile shown in 922, where a third average film thickness is about 0.075 μm to about 0.125 μm. Moving further to the righthand side of the third location 912, a fourth location 914 having a fourth portion of COF film 904 has a thickness profile shown in 924, where a fourth average film thickness is about 0.125 μm to about 0.225 μm.

### Film Thickness Testing—Scratch Test

A scratch test was also performed to verify thickness uniformity of COF films of Example 1. A COF film of Example 1 was synthesized at a furnace temperature of 340° C. for 20 min with a substrate temperature of 130° C. Three scratches were made at three separate locations of the film to test height and roughness consistency. AFM was used to image the scratches (images not shown) and measure film thickness and roughness. The film showed an average film height of 1.09 μm with a standard deviation of 0.077 and a root-mean-square roughness of 102 nm.

### Optical Microscopy

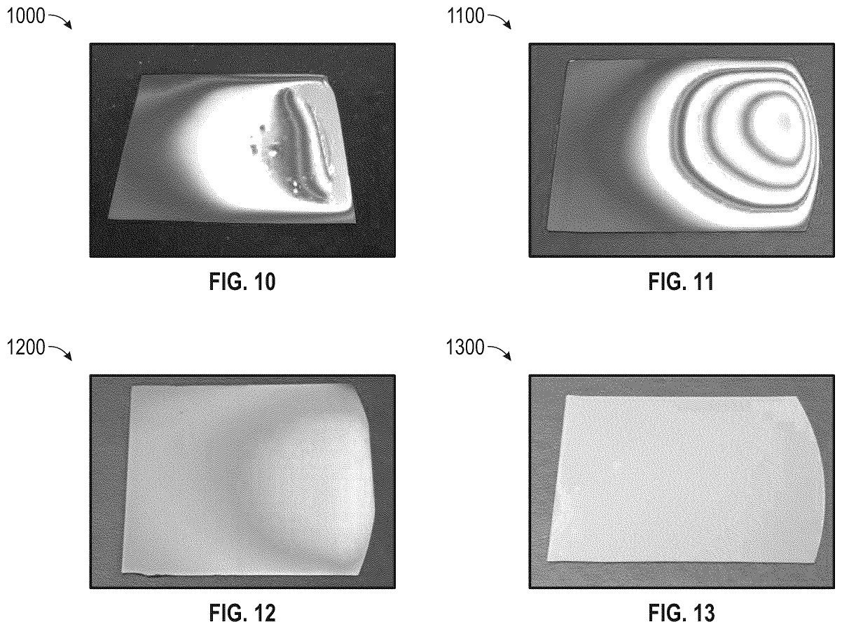

FIG. 10 is an optical microscope image of Example 1, under polarizing lenses.

### Chemical Stability Test

Example 1 COF films were tested for chemical stability by submerging a film in an acid or solvent for 24 hours. Specifically, a COF film of Example 1 was placed in 6 molar hydrochloric acid (HCL), in acetone, and in tetrahydrofuran (THF), separately for 24 hours. Upon being removed from the acid/solvent, the film was dried and then inspected using optical microscopy (images not shown). Chemical stability was maintained in the Example 1 films as evidenced by a uniform film surface showing no visible degradation on the film's surface.

FIG. 11 is an optical microscope image of a 4 cm by 5 cm film of Example 2, under polarizing lenses. The image in FIG. 11 shows formation of conformal COF sheets with more layers deposited in colder regions of the substrate (as evidenced by high birefringence on the right hand side of FIG. 11 where the substrate had a lower temperature during film formation), similar to Example 1 shown in FIG. 10.

FIG. 12 is an optical microscope image of a 4 cm by 5 cm film of Example 3, under polarizing lenses. The image in FIG. 12, shows formation of conformal COF sheets with more layers deposited in colder regions of the substrate (as evidenced by high birefringence on the right hand side of FIG. 11 where the substrate had a lower temperature during film formation), similar to Example 1 shown in FIG. 10.

FIG. 13 is an optical microscope image of a 4 cm by 5 cm film of Example 4, under polarizing lenses. The image in FIG. 13 shows no birefringence due to the amorphous structure of Example 4.

### Film Etching

After synthesis and after testing for film thickness, Example 1 membranes were scratched around the perimeter of substrates with fine tweezers to assist liftoff, and then etched in 1 vol % HF solution to obtain free-standing membranes. Floating membranes were then mounted onto 0.2 m Nylon supports and dried at room temperature. Example 1 films were then characterized to verify chemistry, crystallinity, and morphology. The results are detailed below.

### Scanning Electron Microscopy (SEM)

The film morphology of Example 1 was analyzed using Helios 660 FIB/SEM.

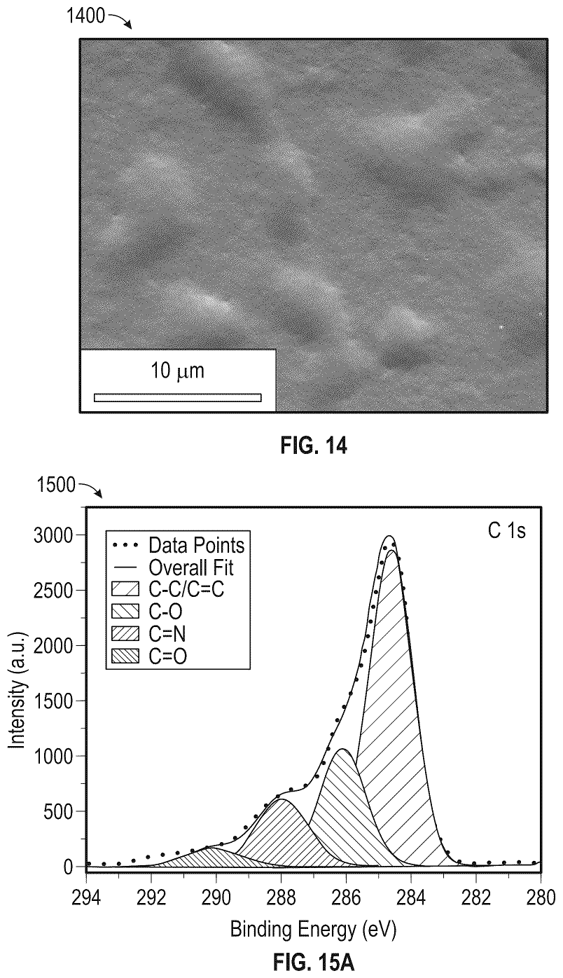

FIG. 14 is an SEM image of Example 1. As shown in FIG. 14, Example 1 consists of a conformal coating with no major cracks or fractures having micron-sized bumps on the surface.

### X-Ray Photoelectron Spectroscopy (XPS)

The successful reaction between monomers to form a COF was confirmed using X-ray photoelectron spectroscopy (XPS) using a PHI Quantera XPS, which uses a focused monochromatic Al K X-ray (1486.7 eV) source for excitation.

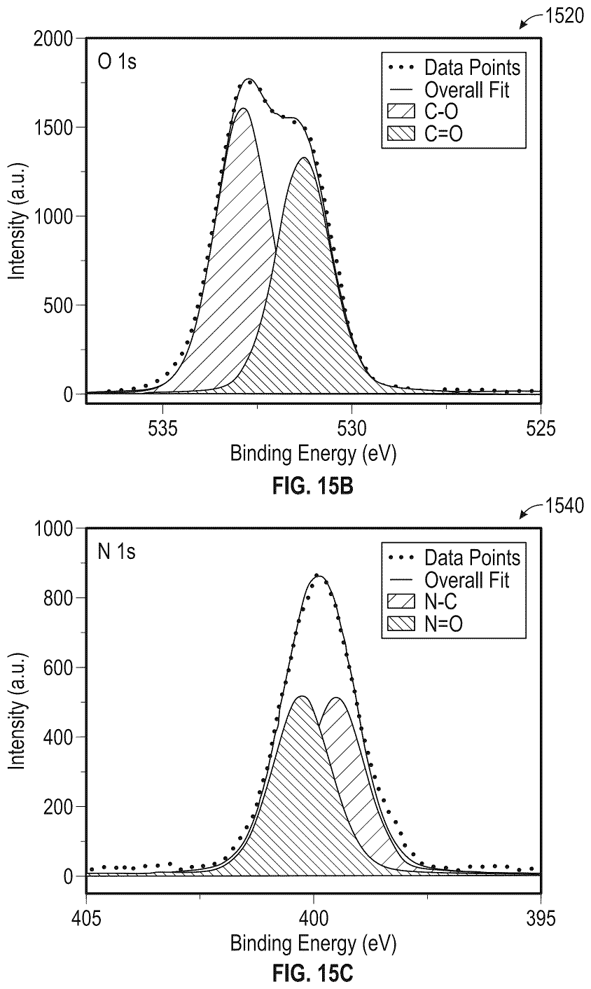

FIG. 15A is a carbon is XPS spectrum of Example 1. In FIG. 15A, a distinct signal is shown for a C═N (carbon nitrogen double bond), which is found only present in the reacted COF linkage and not in the monomers alone.

FIG. 15B is an oxygen is XPS spectrum of Example 1. The spectrum shown in FIG. 15B displays a relatively high amount of O—C (oxygen carbon single) bonds compared to the number of O═C (oxygen carbon double bonds).

FIG. 15C is a nitrogen is XPS spectrum of Example 1. The spectrum shown in FIG. 15C displays a broad nitrogen signal indicating the presence of both N—C (nitrogen carbon single bonds) and N═C (nitrogen carbon double bonds).

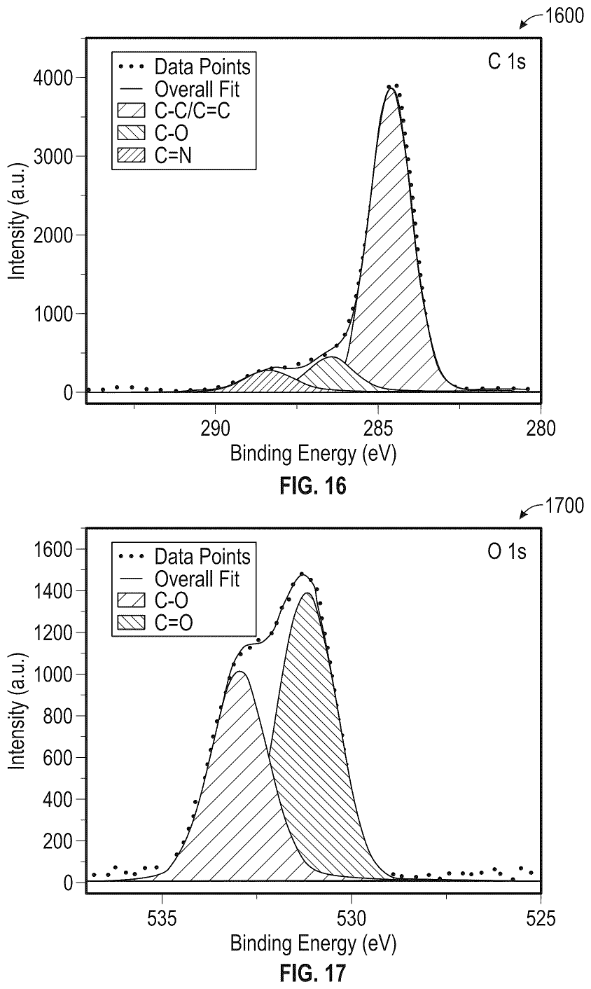

FIG. 16 is a carbon 1s XPS spectrum of Example 2. FIG. 16 shows similar amounts of C—N and C═N bonds, characteristic of an imine linkage, as disclosed in the literature.

FIG. 17 is an oxygen is XPS spectrum of Example 3. FIG. 17 shows relatively large amounts of C═O bonds compared to C—O bonds. The existence of C—O bonds indicates that the film was likely not reacted to competition or that the film possesses large amounts of dangling bonds near the film's surface.

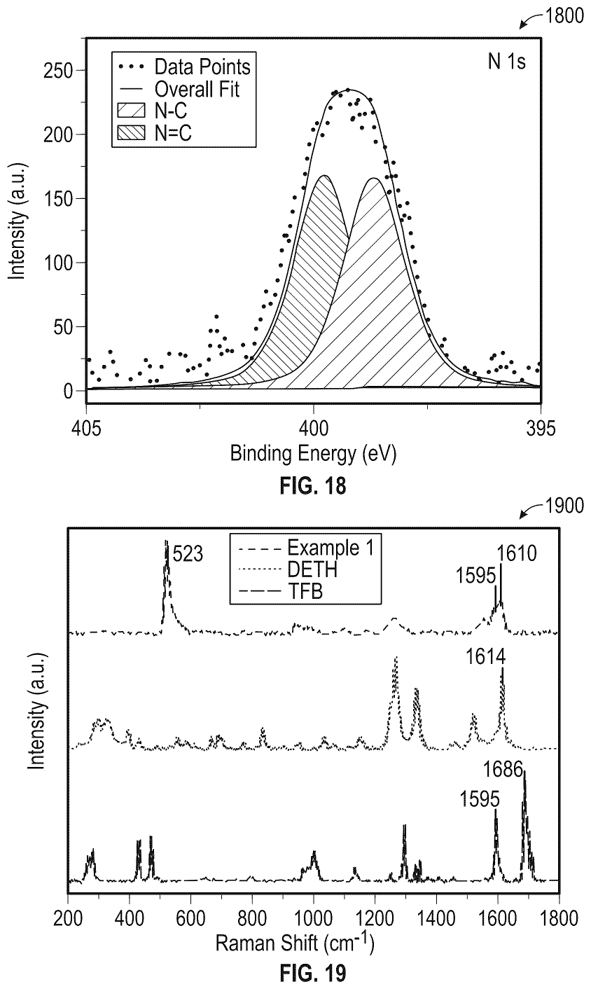

FIG. 18 is a nitrogen is XPS spectrum of Example 4. FIG. 18 shows the characteristic 1:1 ratio of N—C to N═C bonds expected in the polymerized structure caused by the Schiff-base reaction.

### Ultraviolet-Visible Spectroscopy

The formation of a COF for Example 1 was also confirmed using Ultraviolet-Visible Spectroscopy (UV-VIS spectroscopy), using an Agilent Technologies Cary Series UV-vis spectrophotometer from 200-800 nm with a lamp change at 350 nm in transmission mode.

Prior to testing using UV-VIS spectroscopy, Example 1 films were lifted from the SiO₂/Si substrate as described above. UV-VIS spectroscopy was performed on a COF film of Example 1, as well as neat TFB and DETH powders dissolved in dimethyl chloride and drop cast onto glass slides. The resulting UV-VIS spectrum (image not shown) showed two distinct adsorption peaks at 280 and 400 nm, similar to previous reports for hydrazone COFs with the same backbone and pore structure synthesized by methods according to prior art, where the observed peaks are slightly redshifted from the signals found in its constituent monomers.

### Raman Spectroscopy

Raman spectroscopy was used to confirm a successful reaction between two monomers to form a COF according to methods disclosed herein using a Renishaw inVia Raman microscope with RL633 and HPNIR 785 lasers.

Raman spectroscopy was performed on neat TFB monomer and neat DETH monomer in powder form and a spectrum for the monomers prepared as a thin film. Monomer films were prepared using a similar procedure to Example 1, except that a single monomer was placed in the CVD at a position corresponding to 340° C. and condensed onto a Si/SiO₂ substrate placed downstream of the monomer at a position corresponding to 290° C. A Raman peak at 520 cm⁻¹ indicates the presence of the Si/SiO₂ substrate in the spectra which is present due to the thin layer of monomer deposited on the film which did not completely absorb the beam.

FIG. 19 shows Raman spectra measured for Example 1, for neat DETH monomer (evaporated as a thin film onto a substrate), and for neat TFB monomer (evaporated as a thin film onto a substrate). In FIG. 19, Raman spectra show the signals of the aromatic rings of both DETH and TFB at 1614 cm⁻¹ and 1595 cm⁻¹, respectively merged within the large aromatic signal in the spectrum for Example 1. Additionally, the TFB monomer exhibits a prominent aldehyde peak at 1686 cm⁻¹ that is reacted out in the Schiff-base reaction which forms the COF of Example 1. A peak at 1686 cm⁻¹ is absent in the spectrum for Example 1, thus indicating little to no presence of the unreacted TFB monomer. Example 1 also exhibits a prominent peak at 523 cm-1, corresponding to SiO₂, which indicates that the laser is able to penetrate through the entire film and the Si/SiO₂ substrate beneath can be seen.

Raman mapping was also used to confirm the reaction of TFB and DETH over a large area 60×60 μm area of a film of Example 1. A 2D Raman map of relative intensity of the peak at 1690 cm⁻¹ was constructed (not shown). In the map, little to no presence of an aldehyde peak at 1690 cm⁻¹ was observed throughout the film (e.g., relatively low intensity), indicating chemical uniformity throughout the film. Note that the results presented herein do not indicate quantitative amounts of monomer or COF presence, but rather relatively uniform reaction of monomers onto a COF film according to embodiments disclosed herein.

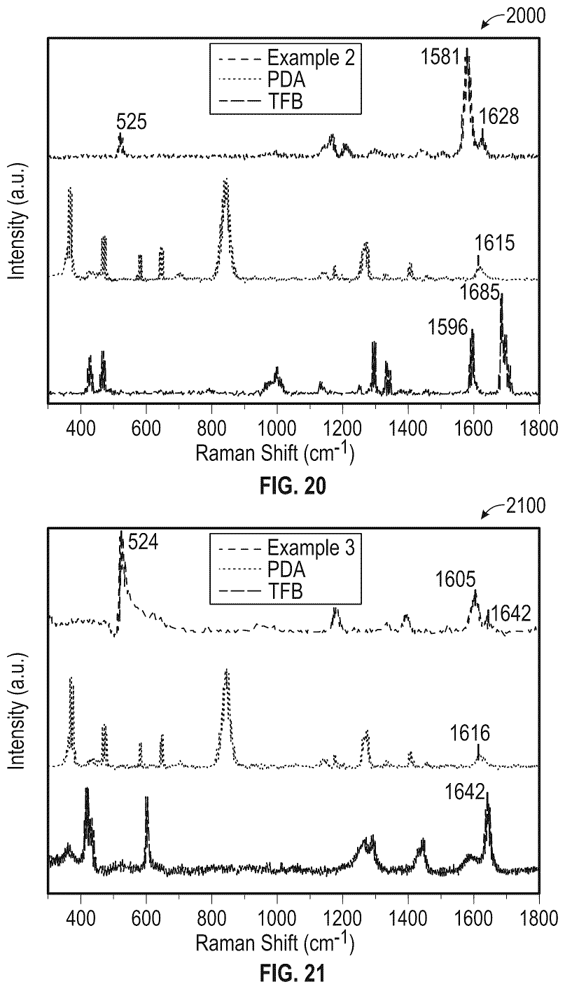

FIG. 20 shows Raman spectra measured for Example 2 and for neat PDA monomer (evaporated as a thin film onto a substrate) and neat TFB monomer (evaporated as a thin film onto a substrate).

FIG. 21 shows Raman spectra measured for Example 3 and for neat PDA monomer (evaporated as a thin film onto a substrate) and neat TFP monomer (evaporated as a thin film onto a substrate).

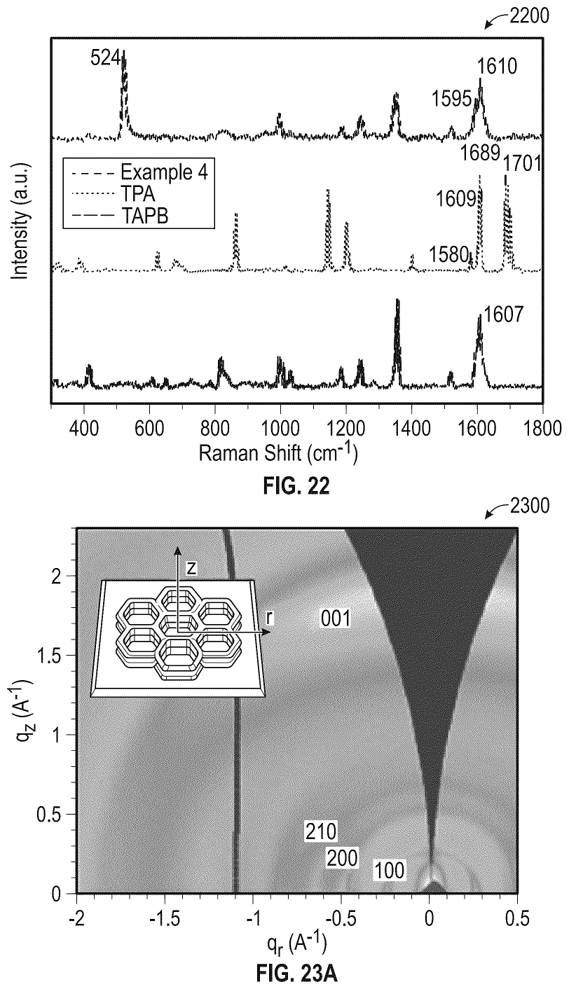

FIG. 22 shows Raman spectra measured for Example 4 and for neat TPA monomer (evaporated as a thin film onto a substrate) and neat TAPB monomer (evaporated as a thin film onto a substrate).

The results presented in FIGS. 20-22 show that the chemical makeup of the synthesized COF differs from the respective constituent monomers, thus showing a reaction consistent with the chemical makeup of the COFs compared to their monomers.

Grazing-Incidence Wide-Angle x-Ray Scattering

Crystallinity and alignment of crystals was investigated using 2D grazing-incidence wide-angle x-ray scattering (GIWAXS). GIWAXS images were generated using the Advanced Photon Source, a U.S. Department of Energy (DOE) Office of Science user facility operated for the DOE Office of Science by Argonne National Laboratory.

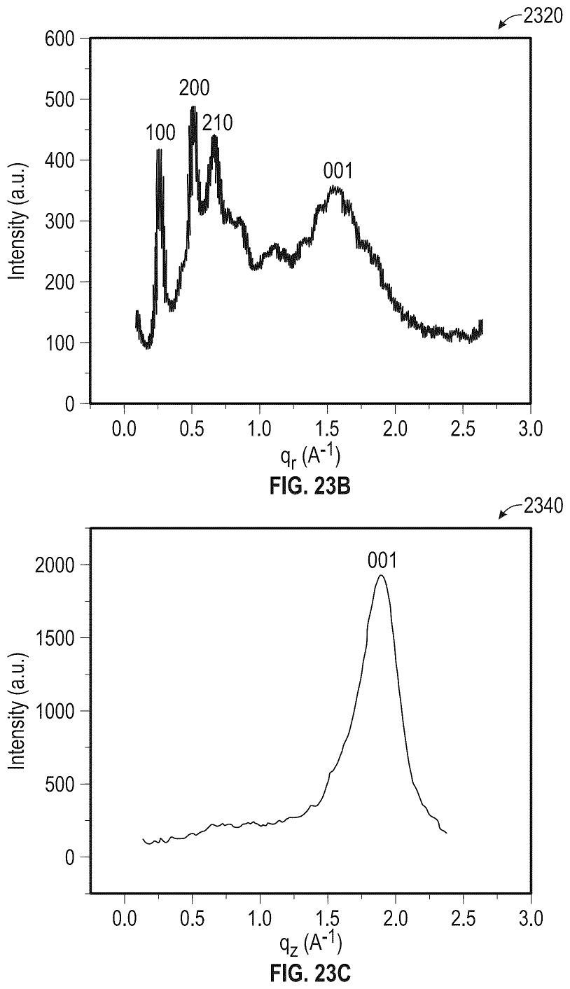

FIG. 23A is a 2D GIWAXS pattern of Example 1 with an insert schematic showing the COF orientation relative to the substrate. Clear crystalline peaks are shown in FIG. 23A at 0.26, 0.52, 0.66, and 1.9 Å⁻¹, which correspond to 2.4, 1.2, 0.95, 0.33 nm crystal spacings, and the 100, 200, and 210 crystal planes, respectively. GIWAXS measurements of the Example 1 film revealed crystalline and vertically ordered crystalline sheets in the vapor deposited COF films.

FIG. 23B is a 1D radially averaged linecut of the 2D GIWAXS pattern corresponding to FIG. 23A in the r-axis, at 2° parallel to the substrate. FIG. 23B shows tight, crystalline characteristic peaks in-plane (r-axis) FIG. 23B shows clear agreement with previously reported powder X-ray diffraction patterns of COF synthesized according to prior art methods.

FIG. 23C is a 1D radially averaged linecut of the 2D GIWAXS pattern corresponding to FIG. 23A in the z-axis, at 87° perpendicular to the substrate. FIG. 23C shows high planarity due to anisotropic scattering in the out-of-plane direction (z-axis). The spacing perpendicular to the substrate observed at 0.33 nm corresponds to the 001-index associated with π-π stacking between COF sheets.

| | Tube | Dwell | Substrate | | | | |
|---|---|---|---|---|---|---|---|
| | Temp. | Time | Temp. (° C.) | | | | |
| | (° C.) | (min) | 240 | 190 | 160 | 130 | 100 |
| Pure | 200 | 1 | * | + | + | + | + |
| Argon | 200 | 20 | * | + | # | + | + |
| (Ar) | 250 | 1 | * | + | # | + | + |
| with | 250 | 20 | * | + | + | # | + |
| Catalyst | 300 | 1 | # | + | * | + | + |
| | 300 | 20 | # | # | * | # | + |
| Pure Ar, | 200 | 1 | * | + | + | + | + |
| no | 200 | 20 | * | + | + | + | + |
| catalyst | 300 | 1 | + | + | * | + | + |
| | 300 | 20 | # | # | * | # | + |
| Pure Ar, | 200 | 1 | * | + | + | + | + |
| with H₂O | 300 | 1 | # | # | * | # | + |

The furnace temperature, substrate temperature, time of growth, presence of octanoic acid catalyst, and moisture (H₂O from a bubbler) were systematically changed, as shown in Table 1. The cells having a plus sign “+” in Table 1 represent conditions where samples did not show both crystalline peaks and anisotropic scattering. The cells having a pound sign “#” in Table 1 represent conditions where samples showed both crystalline peaks and anisotropic scattering. The cells having an asterisk “*” in Table 1 represent conditions not tested due to too large a distance in heat gradient. All experiments were run under 100 sccm Argon with stoichiometric amounts of monomer used. While some showed crystallinity, only the cells marked with “#” showed both crystallinity and planarity. This data shows that the process does not require the presence of catalyst and longer annealing time assists planarity and crystallinity.

Samples grown at a tube temperature of 340° C. for 20 min exhibited sharp, anisotropic peaks by GIWAXS (FIG. 23A), indicating the formation of ordered, crystalline films. By contrast, samples grown for only 1 min or grown at temperatures less than 340° C. showed poor crystallinity and anisotropic scattering features over only limited growth conditions (images not shown). The effect of acid catalysts and water vapor on the CVD growth process were also analyzed. The presence of an evaporated acid catalyst or the presence of H₂O vapor did not significantly improve the film quality or the COF crystallinity. Additionally, heating the monomers to 340° C. for 20 min onto SiO₂/Si substrates at 260° C. yielded the highest quality film. These conditions were used for the remainder of the films formed according to Example 1 unless stated otherwise, and a summary of growth conditions along with GIWAXS spectra is provided in the stability of the monomers used by separately heating TFB and DETH powders to 340° C. and condensing them onto Si/SiO2 substrates.

GIWAXS scattering was also performed to characterize COF films of Example 2 (images not shown). Characteristic peaks which correspond to d-spacings at 1.86 nm and 1.05 nm were observed. Additionally, the strong intensity at the baseline of the GIWAXS shows a high degree of ordering relative to the SiO₂/Si substrates with horizontally aligned crystalline structures.

GIWAXS scattering was also performed to characterize COF films of Example 3 (images not shown). A peak was observed at 1.05 Å⁻¹. Additionally, the strong intensity at the baseline of the GIWAXS shows a high degree of ordering relative to the SiO₂/Si substrates with horizontally aligned crystalline structures.

GIWAXS scattering was also performed to characterize COF films of Example 4 (not shown). An amorphous and densely packed polymeric structure was observed. A possible explanation for this is the large difference in the vapor pressure of each monomer used to prepare Example 4. The large difference in vapor pressure may cause a drastic difference in the supersaturation of each monomer on the substrate surface, where TAPB would have a much higher flux onto the surface than TPA allowing for the creation and reaction of a film but not the formation of a crystalline COF product.

### Transmission Electron Microscopy (TEM)

TEM high-resolution transmission electron microscopy (HRTEM) was performed by using a JEOL 2100F TEM at 180 kV.

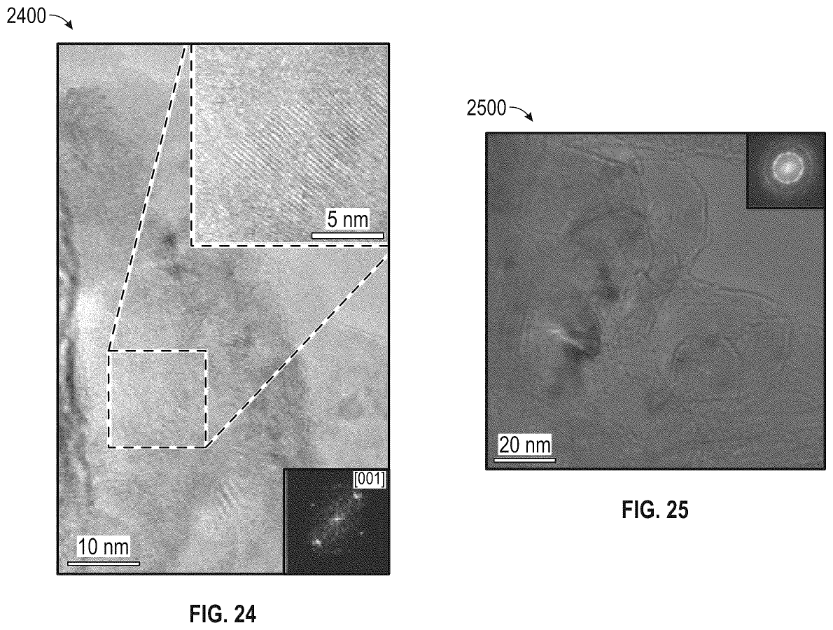

FIG. 24 shows a HRTEM image of Example 1. Each film was lifted from the SiO₂/Si substrate and transferred onto TEM grids prior to imaging. The highlighted HRTEM image in FIG. 24 shows an ordered Example 1 COF film with 0.33 nm spacing, matching the relatively prominent π-π stacking between COF sheets seen in GIWAXS measurements in FIG. 23A. The 0.33 nm spacing can be seen in multiple areas of the film in different directions, corresponding to separate nucleation sites. Highlighted spacings near the top of the image show consistent 0.33 nm spacing in separate directions adjacent to each other, potentially hinting at the formation of an onion structure reported in previous literature.

FIG. 25 shows another HRTEM image of Example 1 and resulting fast Fourier transform (FFT). The image in FIG. 25 shows polycrystal diffraction patterns resembling onion structure reported in previous literature.

### Atomic Force Microscopy (AFM)

Atomic force microscopy (AFM) images were taken using a Park AFM NX20. AFM was conducted to investigate COF film nucleation sites and crystalline growth mechanisms of these films at varying substrate temperatures, generally showing the coalescence of triangular crystallites into a uniform film (images not shown).

AFM analysis of a COF formed at a substrate temperature of 320° C. showed the formation of two domains of 10 nm wide along with 2 nm-thin flakes. Upon scratching a side of the film, the presence of triangular crystallites was observed along the scratched side of the film. These crystallites are believed to be the building blocks shown at higher temperature regions stacked together to form an ordered, polycrystalline COF film, which is further confirmed by the anisotropic scattering shown in the GIWAXS image shown in FIG. 23A.

A height profile of an Example 1 film was investigated via AFM, showing the presence of triangle crystallites (images not shown). Without changing the AFM tip used, the sample was rotated approximately 45° and another height profile was conducted on the same area showing that the triangle crystallites had also rotated with the substrate. The presence of rotated triangular crystallites proves that the observed triangles were not merely artifacts from a broken AFM tip, for example. Such “triangular”-shaped COF flakes have been previously reported, hinting at early film growth mechanisms, specifically at the solid-substrate liquid-precursor condensate interface. Additional tests were conducted showing consistent presence of triangular COF crystallites using different AFM tips on the same sample and the same tip on different samples to ensure veracity of results.

At temperatures of 290° C. and higher, COF domains sparsely populate the substrate, and at lower temperatures the COF produces a uniform coating over the substrate. As the substrate temperature decreased from 340° C., the triangular flakes grew in lateral size and were overtaken by particulate aggregation at 290° C. and 240° C. Particulate aggregation may contribute to an increase in film roughness.

At a substrate temperature of 190° C., distinct COF domains merged to form more smooth films with extremely low roughness of approximately 2-3 nm and a total film thickness of approximately 80 nm. As substrate temperature decreased to 130° C., a simple scratch test followed by AFM imaging revealed layering in the form of ordered triangular sheets. The transition observed from triangular flakes to coalescing agglomerates and thickening films indicates that under optimized conditions, the crystalline sheets grow and agglomerate to produce crystalline COF domains.

The film thickness and uniformity increased significantly as the substrate temperature was reduced to 130° C. to an average of 1.09±0.12 μm thick with a root-mean-square roughness of 102 nm.

As the substrate temperature decreased further to 100° C., which is below the temperature range that ordered, crystalline films can be grown (as proven in the DOE study shown in Table 1), rapid condensation of COFs occurred, leading to highly rough, brittle, and poor films. AFM imaging also indicated that vapor-phase COF growth starts as a triangular monolayer, and with increasing time and decreasing substrate temperature produced multilayer thick, smooth COF films. Combining the nanosized triangular nucleation sites phenomenon observed herein with another report in the literature showing hexagonal morphology around a micron in length scale it may be theorized that COF films grown via CVD originate as nanosized triangles. Specifically, if these triangles continued to grow at a controlled rate as crystals and did not form amorphous polymer around them, then they would grow to form hexagonal crystals, similar to the triangle-to-hexagonal nucleation growth geometry that can be observed in other CVD growth systems, such as 2D crystals of MoS₂.

A height map was constructed using AFM imaging for Example 1 films grown at 300° C. for 1 minute on SiO₂/Si substrate having varying substrate temperatures of 320° C., 300° C., 280° C., 260° C., and 190° C. (images not shown). At a substrate temperature of 320° C., AFM imaging showed triangular COF flakes forming on Si surface with thickness as thin as 2 nm and width ˜175 nm. Two phases were observed including a triangular sheets and larger agglomerates, indicating drastically different elastic properties. Such ‘triangular’-shaped COF flakes of this scale have not been previously reported, hinting at early film growth mechanisms, specifically at the solid-substrate liquid-precursor condensate interface. Crystalline triangular features were observed both on the surface of the substrate and within the softer aggregated particulates. At a substrate temperature of 300° C., AFM imaging showed a morphology of flakes growing laterally and aggregating into film. At a substrate temperature of 280° C., AFM imaging showed a morphology having aggregation creating a smooth (2-3 nm roughness) film.

In summary, Examples disclosed herein demonstrate the ability to synthesize large area, aligned, crystalline films of hydrazone, imine, and ketoenamine COF linkages using systems and methods according to one or more embodiments disclosed herein. Examples disclosed herein also show that CVD processes can be used to quickly produce COF films with high degrees of crystallinity and alignment without the use of solvents or catalysts. By co-evaporating monomer pairs in a CVD tube furnace, large area (20 cm², 40 nm to 1 m-thick) films of multiple COF linkages may be grown on a substrate in one-step 30-minute or less reactions. Film crystallinity and planarity were investigated by GIWAXS, TEM, and AFM, which confirmed the formation of crystalline COF films with a preferred orientation of crystalline domains. Additionally, AFM studies of COF films produced at varying reactor temperatures revealed the formation of sparse, crystalline features at high substrate temperatures and smooth, uniform COF films at lower substrate temperatures. Crystalline COF films were produced with hydrazone, ketoenamine, and imine linkages and amorphous films formed by monomer mixtures were identified.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
providing a first monomer to a first zone in a furnace, a second monomer to a second zone in the furnace, and a substrate to a third zone in the furnace,
wherein the third zone is located downstream from the first zone and the second zone;
heating the furnace to a achieve temperature profile having a range of temperatures comprising at least a first temperature range in the first zone, a second temperature range in the second zone and a third temperature range in the third zone,
wherein heating the first zone to the first temperature range vaporizes the first monomer to form a first vaporized monomer and heating the second zone to the second temperature range vaporizes the second monomer to produce a second vaporized monomer, and
wherein an average temperature of the third temperature range is lower than an average temperature of the first temperature range and an average temperature of the second temperature range; and
absorbing, onto the substrate, the first vaporized monomer and the second vaporized monomer to produce a covalent organic framework (COF).

2. The method of claim 1 further comprising drawing a vacuum within the furnace, wherein, upon drawing the vacuum, the furnace has a pressure in a range of from about 0.001 Torr to about 10 Torr.

3. The method of claim 2 further comprising flowing an inert gas through the furnace at a flow rate in a range of from about 10 sccm to about 300 sccm.

4. The method of claim 1, wherein:
the first monomer has a boiling point in the first temperature range; and
the second monomer has a boiling point in the second temperature range,
wherein when the boiling point of the first monomer is lower than the boiling point of the second monomer, the first zone is located upstream from the second zone, and
wherein when the boiling point of the first monomer is higher than the boiling point of the second monomer, the first zone is located downstream from the second zone.

5. The method of claim 1, wherein heating the furnace occurs for an amount of time in a range of less than about 30 min.

6. The method of claim 1, wherein the first monomer comprises at least one aldehyde end group.

7. The method of claim 1, wherein the second monomer comprises at least one end group selected from the group consisting of an amine, an imine, an imide, and a hydrazide.

8. The method of claim 1 further comprising mixing one or more of the first monomer and the second monomer with a stabilizer.

9. The method of claim 1, wherein the third zone comprises at least a first substrate location having a first substrate temperature within the third temperature range and a second substrate location having a second substrate temperature within the third temperature range, wherein the first substrate temperature and the second substrate temperature are different.

10. The method of claim 9, wherein the COF has a first thickness at the first substrate location and a second thickness at the second substrate location, and wherein the first thickness is greater than the second thickness when the first substrate temperature is lower than the second substrate temperature and the first thickness is less than the second thickness when the first substrate temperature is higher than the second substrate temperature.

11. An article, comprising:
a film of a covalent organic framework (COF) comprising a reaction product of a first monomer and a second monomer, the COF being arranged in a two-dimensional crystalline lattice.

12. The article of claim 11, wherein the film comprises a thickness in a range of from about 20 nm to about 1000 nm.

13. The article of claim 11, wherein a molecular pore size of the COF is in a range of from about 0.5 Å to about 8 nm.

14. A system for producing a covalent organic framework, comprising:
a furnace;
a first monomer, disposed in a first zone within the furnace;
a second monomer, disposed in a second zone within the furnace,
a substrate, disposed in a third zone within the furnace,
wherein the third zone is located downstream from the first zone and the second zone; and
a heating system in the furnace configured to heat the furnace to a temperature profile having a range of temperatures comprising at least a first temperature range in the first zone, a second temperature range in the second zone, and a third temperature range in the third zone,
wherein heating the first zone to the first temperature range vaporizes the first monomer to form a first vaporized monomer and heating the second zone to the second temperature range vaporizes the second monomer to produce a second vaporized monomer,
wherein an average temperature of the third temperature range is lower than an average temperature of the first temperature range and an average temperature of the second temperature range, and
wherein, the first vaporized monomer and the second vaporized monomer absorb onto a surface of the substrate to produce the covalent organic framework (COF).

15. The system of claim 14, wherein the substrate comprises a silicon wafer.

16. The system of claim 14, wherein the substrate comprises a fabric.

17. The system of claim 14, further comprising a vacuum pump located on a downstream side of the furnace and configured to draw a vacuum within the furnace to a pressure in a range of from about 0.001 Torr to 10 Torr.

18. The system of claim 14, further comprising an inert gas source fluidly connected to the furnace and configured to flow an inert gas through the furnace from an upstream side to a downstream side at a flow rate in a range of from about 10 sccm to about 300 sccm.

19. The system of claim 14, wherein the third zone comprises at least a first substrate location having a first substrate temperature within the third temperature range and a second substrate location having a second substrate temperature within the third temperature range, wherein the first substrate temperature and the second substrate temperature are different.

20. The system of claim 19, wherein the COF has a first thickness at the first substrate location and a second thickness at the second substrate location, and wherein the first thickness is greater than the second thickness when the first substrate temperature is lower than the second substrate temperature and the first thickness is less than the second thickness when the first substrate temperature is higher than the second substrate temperature.
